(19) United States
(12) Patent Application Publication
(10) Pub. No.: US 2025/0200470 A1
(43) Pub. Date: Jun. 19, 2025

(54) COMPUTER-AIDED COORDINATION OF RESOURCE DISTRIBUTION

(71) Applicant: PhilanthPro Solutions Inc., Toronto (CA)

(72) Inventor: Nicholas PALAHNUK, Toronto (CA)

(21) Appl. No.: 18/542,326

(22) Filed: Dec. 15, 2023

(51) Int. Cl. G06Q 10/0631; G06Q 50/26

(52) U.S. Cl. CPC G06Q 10/06313; G06Q 50/26

(57) ABSTRACT

A computer-implemented method for supply distribution comprises receiving an episodic resource distribution procedure comprising planned distributions of resources adapted to exhaust a finite resource pool substantially coincident with conclusion of a time horizon. The planned distributions of the resources are recorded upon occurrence thereof, and the quantum is updated at least according to the occurrence of the planned distributions of the resources. Responsive to updating the quantum, the episodic resource distribution procedure is evaluated. If it is determined that the planned distributions of the resources fail to exhaust the finite resource pool substantially coincident with the conclusion of the time horizon, the method prompts for adjustment of the planned distributions of the resources to substantially coincide with the conclusion of the time horizon.

### TECHNICAL FIELD

The present disclosure relates to distribution logistics, and more particularly to computerized systems for enhancing the distribution of resources.

### BACKGROUND

Distribution of finite resources has been a perennial problem. For example, in a military context, there is an old adage that “an army travels on its stomach”—an army that isn't fed cannot fight. Likewise, ammunition and other (non-food) supplies must also be distributed among the soldiers. This is not a trivial matter, and the efficient distribution of these resources can be critical to achieving the target mission. For example, where ammunition supplies are limited, these should be directed to where they will provide the most impact. Likewise, warfighters who are in the thick of the fighting may have a greater need for food and water than those who are well behind the lines. Supplies need to go where they will achieve the desired impact.

Similarly, in a manufacturing context, supplies and components must be provided to various factories to support the production of finished products. Where supplies and components can be put to more than one use (e.g. bolts of a particular type may be used to manufacture one of a plurality of products), the impact of the product on the target objective should be considered. Some of the products may be more profitable, or critical to a business plan, or even crucial to a larger societal objective. To consider a hypothetical example, the same chemical compound may be an ingredient in two different lifesaving medications treating two different medical conditions with differing prevalence, transmissibility and geographic distribution.

Time horizons are also important to determining the distribution of resources. In some cases, the nature of the resources may dictate the time horizon—for example, the resources may be perishable and must be distributed before their utility wanes. In other cases, the nature of the situation may dictate the time horizon. Returning to the military context, it does no good for critical ammunition and supplies to arrive too late, only after an army's lines have already been overrun. Likewise, it is futile to distribute vaccines after they have lost their potency, or after the condition they were meant to protect against has already ravaged the relevant population.

### SUMMARY

In one aspect, a computer-implemented method for supply distribution comprises receiving an indication of a target mission and identifying a plurality of target-mission-supporting objectives associated with the target mission and presenting the target-mission-supporting objectives. Each target-mission-supporting objective has a unit resource requirement, and there is a correlation between the respective unit resource requirement and a projected impact of the respective target-mission-supporting objective in support of the target mission. The method further comprises receiving a selection of at least one of the target-mission-supporting objectives. At least one of the selected target-mission-supporting objective(s) includes distribution of physical supplies. The method further comprises receiving an indication of a time horizon, receiving an indication of a quantum of a finite resource pool, and, from the time horizon and the quantum, determining an episodic resource distribution procedure comprising planned distributions of resources adapted to exhaust the finite resource pool substantially coincident with conclusion of the time horizon. The method yet further comprises generating a dashboard indicating the projected impact of each of the selected target-mission-supporting objective(s) in support of the mission and causing the dashboard to be displayed on a display device. The method further comprises causing execution of at least a first episode of the resource distribution procedure, whereby the resources are distributed to the selected target-mission-supporting objective(s) to cause the distribution of the physical supplies. After executing each episode of the resource distribution procedure, the method generates an updated dashboard updating the projected impact of each selected one of the target-mission-supporting objective(s) in the dashboard using the distributed resources and the unit resource requirement for the respective selected objective(s) to calculate the updated projected impact and causes the updated dashboard to be presented on the display device.

In an embodiment, for the selected target-mission-supporting objective(s) that include distribution of physical supplies, each correlation is between the respective unit resource requirement and a volume of the respective physical supplies, whereby the projected impact of the respective target-mission-supporting objective in support of the target mission is measured by the volume of the respective physical supplies that is distributed.

In an embodiment, receiving the identification of the target mission comprises presenting a plurality of sample mission-supporting objectives, wherein each of the sample mission-supporting objectives represents a sample mission, receiving a selection of one of the sample objectives, and identifying the sample mission represented by the selected one of the sample mission-supporting objectives as the target mission.

In an embodiment, receiving the identification of the target mission and identifying a plurality of target-mission-supporting objectives associated with the target mission comprises maintaining a database of potential mission-supporting objectives. Each of the potential mission-supporting objectives supports a particular one of a plurality of potential missions, and for a subset of the potential missions, each of the potential missions in the subset is supported by a plurality of the potential mission-supporting objectives. The method further comprises receiving a selection of one of the potential mission-supporting objectives, and identifying as the plurality of mission-supporting objectives associated with the target mission those ones of the potential mission-supporting objectives supporting an identical one of the plurality of potential missions as the selected one of the potential mission-supporting objectives.

In some embodiments, the target mission is a philanthropic target mission.

In some embodiments, the quantum is renewable by a replenishment rate.

In some embodiments, the episodic resource distribution procedure is adjustable.

In some embodiments, the time horizon is infinite.

In some embodiments, the method further comprises causing an initial version of the dashboard to be presented on the display device before causing execution of the first episode of the resource distribution procedure.

In another aspect, a computer-implemented method for supply distribution, comprises receiving an indication of a time horizon, receiving an indication of a quantum of a finite resource pool, from the time horizon and the quantum, determining an episodic resource distribution procedure comprising planned distributions of resources adapted to exhaust the finite resource pool substantially coincident with conclusion of the time horizon, and prompting distribution of the resources according to the episodic resource distribution procedure.

In an embodiment, the method further comprises monitoring for confirmation from a target of the resources that the resources have been received, and, responsive to receiving the confirmation, recording occurrence of the respective planned distribution of the resources.

In an embodiment, the method further comprises updating the quantum, evaluating the episodic resource distribution procedure in response to updating the quantum, and responsive to determining that the planned distributions of the resources fail to exhaust the finite resource pool substantially coincident with the conclusion of the time horizon, prompting adjustment of the planned distributions of the resources to substantially coincide with the conclusion of the time horizon.

In some embodiments, the quantum is renewable by a replenishment rate.

In some embodiments, the episodic resource distribution procedure is adjustable.

In some embodiments, the time horizon is infinite.

In a further aspect, a computer-implemented method for supply distribution comprises receiving an episodic resource distribution procedure comprising planned distributions of resources adapted to exhaust a finite resource pool substantially coincident with conclusion of a time horizon. The method records the planned distributions of the resources upon occurrence thereof, updates the quantum at least according to the occurrence of the planned distributions of the resources, and responsive to updating the quantum, evaluates the episodic resource distribution procedure. Responsive to determining that the planned distributions of the resources fail to exhaust the finite resource pool substantially coincident with the conclusion of the time horizon, the method prompts adjustment of the planned distributions of the resources to substantially coincide with the conclusion of the time horizon.

In an embodiment, the quantum is renewable by a replenishment rate, and updating the quantum comprises updating the quantum according to the replenishment rate.

In some embodiments, the quantum is renewable by a replenishment rate.

In some embodiments, the time horizon is infinite.

In other aspects, a computer program product comprises at least one tangible, non-transitory computer-readable medium containing instructions which, when executed by a computer, cause the computer to implement any of the above methods, and a data processing system comprises at least one processor and memory containing instructions which, when executed by the data processing system, cause the data processing system to implement any of the above methods.

### BRIEF DESCRIPTION OF THE DRAWINGS

These and other features will become more apparent from the following description in which reference is made to the appended drawings wherein:

FIG. 1 is a flow chart showing a first illustrative computer-implemented method for supply distribution;

FIG. 1A is a flow chart showing an illustrative alternate implementation of the first illustrative computer-implemented method for supply distribution shown in FIG. 1;

FIG. 2 is a flow chart showing a second illustrative computer-implemented method for supply distribution;

FIG. 2A is a flow chart showing an alternate implementation of the second illustrative computer-implemented method for supply distribution shown in FIG. 2;

FIG. 3A shows a first illustrative episodic resource distribution procedure represented as a bar graph showing distributions for each month of a one year time horizon;

FIG. 3B shows a first dashboard indicating the projected impact of a target-mission-supporting objective in support of a target mission for each month of a one year time horizon, in accordance with the first illustrative episodic resource distribution procedure shown in FIG. 3A;

FIG. 3C shows a first overview display comparing a base plan with a current projected plan in respect of the first illustrative episodic resource distribution procedure shown in FIG. 3A;

FIG. 4A shows a second illustrative episodic resource distribution procedure represented as a bar graph showing distributions for each month of a one year time horizon;

FIG. 4B shows a second dashboard indicating the projected impact of a target-mission-supporting objective in support of a target mission for each month of a one year time horizon, in accordance with the second illustrative episodic resource distribution procedure shown in FIG. 4A;

FIG. 4C shows a second overview display comparing a base plan with a current projected plan in respect of the second illustrative episodic resource distribution procedure shown in FIG. 4A;

FIG. 5 shows an illustrative computer system in respect of which aspects of the present technology may be implemented; and

FIG. 6 shows an illustrative smartphone in respect of which aspects of the present technology may be implemented.

### DETAILED DESCRIPTION

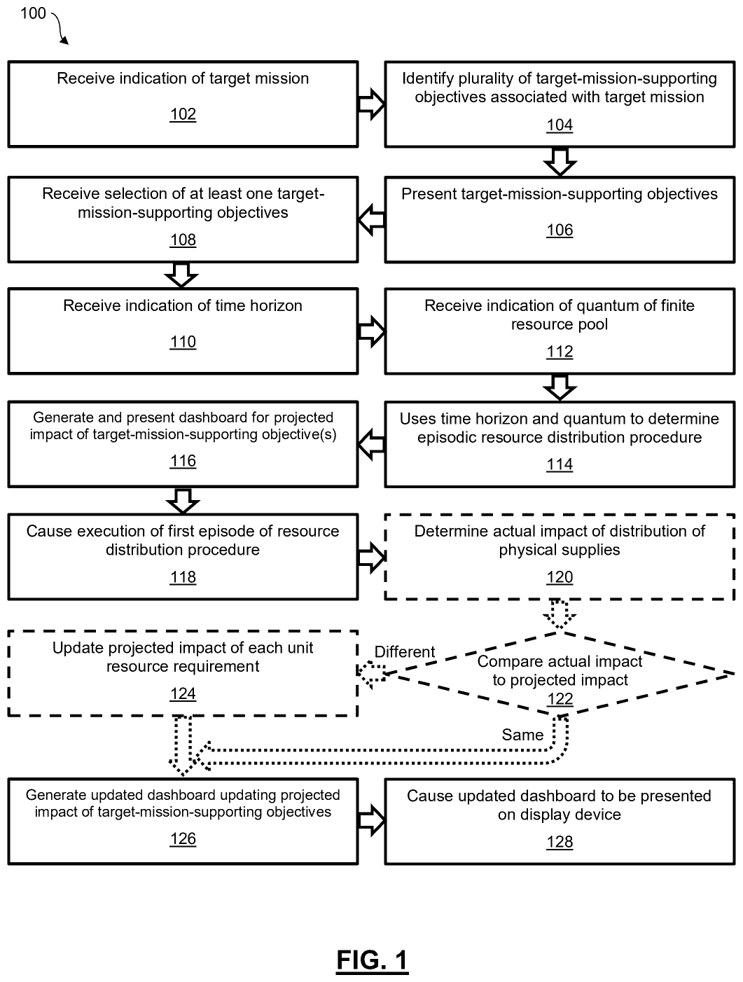

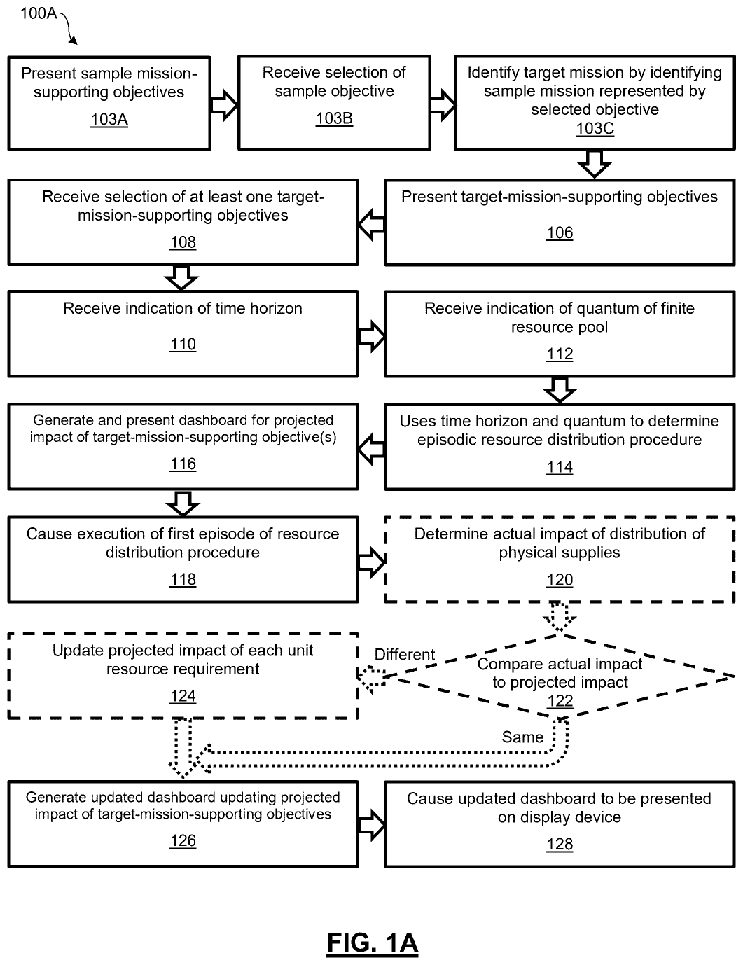

Reference is now made to FIG. 1, which is a flow chart showing a first illustrative computer-implemented method for supply distribution.

At step 102, the method 100 receives an indication of a target mission. The target mission may be, for example, a military mission, a manufacturing mission, a medical mission, a philanthropic mission, or another type of mission. A military mission may be, for example, the capture or defence of a particular objective. A manufacturing mission may be, for example, the manufacture of a specific quantity of a particular product. A medical mission may be, for example, the treatment or inoculation of a particular population. A philanthropic mission may be, for example, the provision of food, water or medicine, improvement in literacy, women's health, civil rights, among other missions. The foregoing missions are merely illustrative examples and are not intended to be limiting.

At step 104, the method 100 identifies a plurality of target-mission-supporting objectives associated with the target mission. In the case of a military target mission to capture a particular town, target-mission-supporting objectives may include securing particular roads or bridges, neutralizing radar installations or weapon emplacements, or capturing key personnel. In the case of a manufacturing target mission, target-mission-supporting objectives may include procurement and delivery of particular ingredients or components, arranging for personnel, or securing particular machinery. In the case of a medical target mission to treat an outbreak of a particular disease in a particular location, target-mission-supporting objectives may include arranging for trained medical personnel, training other personnel (e.g. local personnel), procuring medical supplies and personal protective equipment and arranging transport to a particular location. In the case of a philanthropic target mission to improve literacy, target-mission-supporting objectives may include procurement and delivery of books and training of teachers. In the case of a philanthropic target mission to alleviate a particular illness, target-mission-supporting objectives may include foundational research into causes, prophylactic measures such as vaccines, education for avoidance/prevention, provision of hospital or hospice care, and procurement and delivery of materials for treatment, such as medications and/or medical equipment. In the case of a philanthropic target mission to alleviate persistent hunger in an impoverished geographical region, target-mission-supporting objectives may include the provision of immediately consumable food, provisions of seeds or seedlings for food crops, or provision of animals for sustained food production. These are merely illustrative examples, and are not limiting.

Of note, each target-mission-supporting objective has a unit resource requirement, and there is a correlation between the respective unit resource requirement and a projected impact of the respective target-mission-supporting objective in support of the target mission. Some non-limiting illustrative examples are described below.

At step 106, the method 100 presents the target-mission-supporting objectives identified at step 104. For example, the target-mission-supporting objectives may be presented on a display screen of a computer system implementing the method 100.

At step 108, the method 100 receives a selection of at least one of the target-mission-supporting objectives. Depending on the context, the selection received at step 108 may be of a single target-mission-supporting objective, or a plurality of target-mission-supporting objectives. At least one of the selected target-mission-supporting objectives includes distribution of physical supplies, although some of the selected target-mission-supporting objectives may not include distribution of physical supplies.

For example, in a military context, the selected target-mission-supporting objectives that include distribution of physical supplies may include distribution of rations and ammunition. The selected target-mission-supporting objectives may also include interception or jamming of enemy signals, which may not require distribution of physical supplies. In this regard, it should be noted that in the military context, the term “distribution of physical supplies” is not intended to encompass the movement of personnel or combat (as distinguished from transport) vehicles-movement of combat personnel and combat vehicles belongs to the realm of military strategy and tactics and is entirely outside the scope of the present application.

In a medical context, examples of selected target-mission-supporting objectives that include distribution of physical supplies may include distribution of medical supplies and medical equipment. Examples of selected target-mission-supporting objectives that do not include distribution of physical supplies may include training of local personnel.

In the case of a philanthropic target mission to improve literacy, target-mission-supporting objectives that include distribution of physical supplies may include procurement and delivery of books and stationery, and target-mission-supporting objectives that do not include distribution of physical supplies may include training and salary for teachers. In the case of a philanthropic target mission to alleviate a particular illness, target-mission-supporting objectives that include distribution of physical supplies may include procurement and delivery of medications and/or medical equipment, whereas target-mission-supporting objectives such as foundational research and education for avoidance/prevention may not include distribution of physical supplies.

As noted above, each target-mission-supporting objective has a unit resource requirement, and there is a correlation between the respective unit resource requirement and a projected impact of the respective target-mission-supporting objective in support of the target mission.

In the military context, a unit resource requirement may be, for example, a single round of ammunition or a single pre-loaded ammunition magazine or a single MRE (Meal Ready to Eat) ration. In the case of ammunition, the expected needs of a warfighter in active combat may be approximated (e.g. from prior experience), so that the correlation with the projected impact may be obtained. For example, if a soldier in urban combat is expected to consume a number (X) of 30-round magazines of NATO 5.56 mm ammunition daily, then every X such magazines has a projected impact of sustaining one soldier per day in urban combat. A similar approach could be taken for artillery rounds or MREs.

In the medical context, a unit resource requirement may be, for example, a vaccine dose. For a single-dose vaccine, the correlation between the respective unit resource requirement and the projected impact is straightforward: one dose results in one vaccinated person. For a multi-dose vaccine, the correlation may be a ratio, for example.

In the case of a philanthropic target mission to improve literacy, one example of a unit resource requirement may be a specialized “learn to read” book, where the correlation between the respective unit resource requirement and the projected impact is that one book equips one student to learn to read, assuming an available teacher. Because teacher training is also required, a unit resource requirement may also be the monetary cost of training and paying the teacher, e.g. $Y will train one teacher and pay them to teach for one year. In the case of a philanthropic target mission to alleviate a particular illness, one unit resource requirement may be a single unit of medical equipment (e.g. a dialysis machine) and another unit resource requirement may be the monetary cost of training and paying the operator, and yet another unit resource requirement may be reflected as the cost of employing a skilled kidney disease researcher to perform foundational kidney disease research for a year.

In the context of a philanthropic target mission to alleviate persistent hunger in an impoverished geographical region, one example of a unit resource requirement may be a bag of rice, or a poultry animal capable of egg production, or an ungulate (e.g. goat or cow) capable of milk production.

In many contexts a unit resource requirement can be usefully expressed as a dollar (or other currency) value, that is, as the cost of the unit resource requirement. For example, if a specialized “learn to read” book is a unit resource requirement and costs $5.00 then the unit resource requirement may be expressed monetarily as “$5.00”. Or, if a goat is a unit resource requirement and costs $80.00 then the unit resource requirement may be expressed monetarily as “$80.00”. These are merely examples and are not limiting.

As noted above, at least one of the selected target-mission-supporting objectives will include distribution of physical supplies, although some of the selected target-mission-supporting objectives may not include distribution of physical supplies. As used in this context, the term “physical supplies” includes, but is not limited to, livestock, such as for egg or milk production, or for consumption, and includes insects when the same are farmed as a protein source. As also noted above, there is a correlation between the respective unit resource requirement and a projected impact of the respective target-mission-supporting objective in support of the target mission. In some embodiments, for the selected target-mission-supporting objective(s) involving distribution of physical supplies, the correlation is between the respective unit resource requirement and a volume of the respective physical supplies, and the projected impact of the respective target-mission-supporting objective in support of the target mission is measured by the volume of the respective physical supplies that is distributed. The term “volume”, as used in this context, includes both countable items (e.g. books, ammunition cartridges, or livestock) as well as non-countable measurable items (e.g. clean water). Since in many contexts a unit resource requirement can be usefully expressed as a dollar (or other currency) value, it is possible to express the projected impact in a dollar (or other currency) value. For example, X dollars may result in Y books, Y ammunition cartridges or Y chickens with a respective corresponding projected impact.

At step 110, the method 100 receives an indication of a time horizon. The time horizon received at step 110 may be a fixed time horizon, for example one day, one week, one month, one year, ten years, etc. or may be an infinite time horizon. A fixed time horizon may be used where a target mission has a deadline. In the military context, it may be necessary that a specific target mission be completed by a particular deadline in support of some other objective, e.g. it may be necessary to capture a particular town by a particular time in order to block the enemy's line of retreat. In the medical context, it may be necessary to complete inoculations within a given geographic area before a rapidly spreading disease is expected to reach that area (or within enough time for the inoculations to take effect before the disease arrives). In the manufacturing context, it may be necessary to complete a production run before a contractually mandated delivery date, or in time to distribute a product to retailers for sale in advance of a holiday (e.g. toys for Christmas or Chanukah, small confections for Halloween, boxed chocolates or flowers for Valentine's Day). In the philanthropic context, a closely held foundation may wish to exhaust its endowment within a specified period, so as to have a finite time horizon, or may wish for the foundation to continue indefinitely, so as to have an infinite time horizon. The foregoing are merely illustrative, non-limiting examples.

At step 112 the method 100 receives an indication of a quantum of a finite resource pool. A finite resource pool is reasonably capable of exhaustion, although it may be subject to replenishment. Thus, the quantum of the finite resource pool may be renewable by a replenishment rate.

For example, a resource pool of ammunition, MREs, or vaccine doses may be replenished as more ammunition, MREs, or vaccine doses are manufactured such that they can be added to the resource pool, but the pool can still be exhausted if the resource pool is depleted faster than it can be replenished. The replenishment need not be from an external source; but may be internal or inherent (with or without human assistance). For example, if the resource pool is the trees in a forest, the trees will naturally replenish; this may also be the case where the resource pool is livestock capable of reproduction where both sexes are present and they are permitted to mingle. Or, in a managed forest trees may be planted, or livestock may be the subject of an intentional breeding program. Another example is where a resource pool is a quantum of money, it can be replenished by being invested at interest, or through stock dividends. Thus, the replenishment rate may be a variable replenishment rate, or may be a fixed replenishment rate. Some resource pools may not be capable of replenishment. Further, while some resource pools may have a positive replenishment rate, other resource pools may have a (net) negative replenishment rate, for example by spoliation or natural decline, where a resource pool is a quantum of money, by inflation, taxation or negative interest rates. A resource pool may also comprise a cryptocurrency, which may be replenished by mining, for example.

A resource in a resource pool may be a physical object, which in turn may be an inanimate object, such as books, pencils, or vaccines, or animate objects, such as plants or livestock. For the avoidance of doubt, in no circumstance contemplated herein can a human being be considered a resource in the context of a resource pool. Replenishment in the context of food animals (which includes cases where the animal produces food, such as milk or eggs, is consumed as food, or both) as part of a resource pool may comprise breeding and/or attrition, (which includes cases where the animal produces food, such as milk or eggs, is consumed as food, or both). Replenishment in the context of service animals may include breeding/acquisition and/or training, for example in the case of guide dogs or other types of service or support animals (including without limitation monkey helpers for persons with physical limitations).

It should be noted here that steps 102, 104, 106, 108, 110 and 112 may occur in a different order than the order set out above, or substantially in parallel.

For example, step 102 (identification of the target mission) may be carried out in combination with step 104 (identifying a plurality of target-mission-supporting objectives associated with the target mission). As shown in FIG. 1A, step 103A presents a plurality of sample mission-supporting objectives. Each of the sample mission-supporting objectives represents a sample mission. Then, sub-step 103B receives a selection of one of the sample mission-supporting objectives, and then step 103C identifies the target mission by identifying the sample mission represented by the selected one of the sample mission-supporting objectives as the target mission. The method then proceeds to step 106 to present a plurality of (additional) target-mission-supporting objectives associated with the target mission identified at step 104. The remainder of the steps are identical to those shown in FIG. 1, with like references denoting like features.

The variation of the method shown in FIG. 1A has particular application in a charitable or philanthropic context. For example, a wealthy person or family may wish to endow a foundation with the intention of making the world a better place, but lack a specific idea of how they wish to do so, as there are many such opportunities. Thus, where such a person or family cannot decide what the target mission is, they can be given some sample objectives and pick one of interest, and then the system can extract the mission from that selection. For example, there may be some sample mission-supporting objectives supporting “decrease hunger” as the target mission, some sample mission-supporting objectives supporting “environmental protection” as the target mission, some sample mission-supporting objectives supporting “advance women's rights” as the target mission, some sample mission-supporting objectives supporting “LGBTQIA2S+ interests” as the target mission, and so on. Once a mission-supporting objective is selected, the target mission can be determined from that, and then additional mission-supporting objectives can be prevented for only for that target mission. To use a simple example, if they choose “inner city library programs” as a mission-supporting objective, the system can extract “literacy” as the target mission, and then present mission-supporting objectives only for literacy. So, they might have chosen “inner city library programs” initially, but end up ultimately choosing a different mission-supporting objective for the “literacy” target mission.

A similar approach can be used with implicit rather than explicit identification of the target mission. The system may maintain a database of potential mission-supporting objectives, where each of the potential mission-supporting objectives supports a particular one of a plurality of potential missions. For a subset of the potential missions, each of the potential missions in the subset is supported by a plurality of the potential mission-supporting objectives. The subset may be a single one of the potential missions, some of the potential missions, or all of the potential missions-some of the potential missions may have only a single potential mission-supporting objective associated therewith, but there is at least one potential mission for which a plurality of potential mission-supporting objectives are associated therewith. The system receives a selection of one of the potential mission-supporting objectives, and then identifies as the plurality of mission-supporting objectives associated with the target mission those ones of the potential mission-supporting objectives supporting an identical one of the plurality of potential missions as the selected one of the potential mission-supporting objectives. Preferably, the potential mission-supporting objectives are organized into groups according to which one of the plurality of potential missions is supported by particular ones of the potential mission-supporting objectives. Still more preferably, identification of the target mission is implicit from the one of the groups to which the selected one of the potential mission-supporting objectives belongs. Thus, in this embodiment the mission-supporting objectives are grouped by mission so that the target mission is identified implicitly by identifying the group of mission-supporting objectives.

At step 114, the method 100 uses the time horizon and the quantum to determine an episodic resource distribution procedure. The episodic resource distribution procedure comprises planned distributions of resources that are adapted to exhaust the finite resource pool substantially coincident with conclusion of the time horizon. Depending on the context, the episodic resource distribution procedure may be a regular periodic resource distribution procedure, such as hourly, daily, weekly, monthly, quarterly or annually, for example, or a sporadic resource distribution procedure, which may for example be responsive to specific requirements for resources in the resource pool, among other factors. The episodic resource distribution procedure may be adjustable.

In the military context, for example, MREs may initially be distributed daily at a fixed rate of two MREs per soldier per day rather than three per day, if distribution at a rate of three MREs per soldier per day would be expected to exhaust the resource pool of MREs before conclusion of the time horizon (e.g. expected mission completion). There may not be enough MREs to feed every soldier three times a day. As casualties are (regrettably) taken, there may be fewer soldiers to feed, so that continued distribution of two MREs per soldier per day would then be expected to exhaust the resource pool of MREs only after conclusion of the time horizon. In response, the rate of distribution might be increased to three MREs per soldier per day.

In a charitable or philanthropic context, the finite resource pool may be a quantum of money (a fund) held by a foundation and intended to be distributed in the form of grants directed to the target-mission-supporting objective(s) furthering the target mission. The episodic resource distribution procedure will comprise timing and amounts of the grants. Where the finite resource pool is a quantum of money, the resources (money) may be allocated to different things, and that allocation can be changed from time to time; i.e. resources can be transferred from one type to another within the resource pool. Some resources may be committed (not transferrable) and others may be uncommitted (transferrable).

In one embodiment, the foundation is to continue indefinitely, and the episodic resource distribution procedure may be calculated to disburse only the annual income from the fund rather than principal, and so will take into account the replenishment rate. The episodic resource distribution procedure may also take account of inflation, so that not all of the annual income is disbursed, with some of the annual income allocated to increase the principal commensurate with inflation. The episodic resource distribution procedure may include regular planned distributions, or sporadic distributions based on actual income and inflation.

In another embodiment, the foundation is intended to continue for a definite period, such as ten years, or twenty years following the death of the benefactor, for example. In this embodiment, the episodic resource distribution procedure may be calculated to disburse not only the annual income from the fund but also the principal, so as to exhaust the fund (or leave a predefined amount of the fund) at the end of the definite period, again taking account of the replenishment rate and likely also taking account of inflation. This is similar to financial planning for retirement, but applied in a philanthropic context.

At step 116, the method 100 generates a dashboard indicating the projected impact of each selected target-mission-supporting objective in support of the mission. The method 100 will preferably present an initial version of the dashboard on the display device before causing execution of the first episode of the resource distribution procedure; alternatively the dashboard may not be displayed initially. At step 118, the method causes a first episode of the resource distribution procedure to be executed. Execution of the episode(s) of the distribution procedure may be caused, for example, by sending signals (e.g. e-mails) to human personnel instructing them to take the necessary steps, or in an entirely automated manner. The latter process may be used, for example, in an automated manufacturing context where components may be moved from storage to an assembly line, or in a charitable or philanthropic context where an automated transfer of funds from a foundation to a grant recipient may be performed.

Whether by implementation of instructions provided to human personnel or by automated process, the resources are distributed to the selected target-mission-supporting objective(s). As noted above, at least one of the selected target-mission-supporting objectives will include distribution of physical supplies. Therefore, distribution of the resources to the selected target-mission-supporting objective(s) will, directly or indirectly, cause the distribution of those physical supplies to occur. For example, where a foundation provides a grant to a literacy organization for the purpose of purchasing and distributing physical copies of early readers to inner city schoolchildren, the literacy organization will in due course purchase and distribute those early readers and thus physical supplies will be distributed.

At optional step 120, the method 100 measures results of the distribution of the physical supplies resulting from step 118 to determine the actual impact of the distribution of the physical supplies. At optional step 122, the method 100 compares the actual impact to the projected impact. If the actual impact is different from the projected impact (“different”) at step 122 by a threshold amount (which may be zero or a non-zero value), then the method proceeds to optional step 124 to update the projected impact of each unit resource requirement. For example, in a military context, it may become apparent that soldiers are consuming more or fewer MREs and/or cartridge magazines per day. After step 124, or from step 122 if the difference between the projected impact and the actual impact does not exceed the threshold (“same”) at step 122, the method 100 proceeds to step 126.

At step 126, after executing an episode of the resource distribution procedure at step 118 (and after steps 120 to 124 when present), the method generates an updated dashboard updating the projected impact of each selected one of the target-mission-supporting objectives in the dashboard. The updating at step 126 is carried out using the distributed resources and the unit resource requirement for the respective one of the objectives to calculate the updated projected impact. As noted above, there is a correlation between the respective unit resource requirement and the projected impact. In some contexts the projected impact of the respective target-mission-supporting objective in support of the target mission can be measured by the volume of the respective physical supplies that is distributed and the unit resource requirement can be usefully expressed as a currency value. Thus, in some contexts the impact can be directly measured by the currency value, e.g. X dollars may result in Y books and therefore Y children who have learned to read. Other determinations of projected impact can also be used.

At step 128, the method 100 causes the updated dashboard to be presented on a display device.

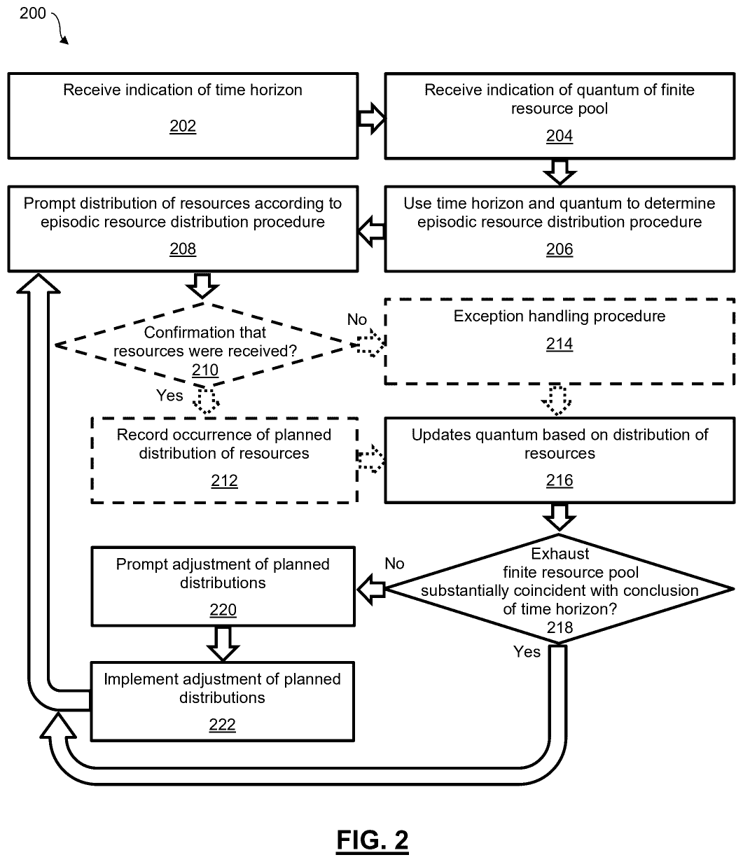

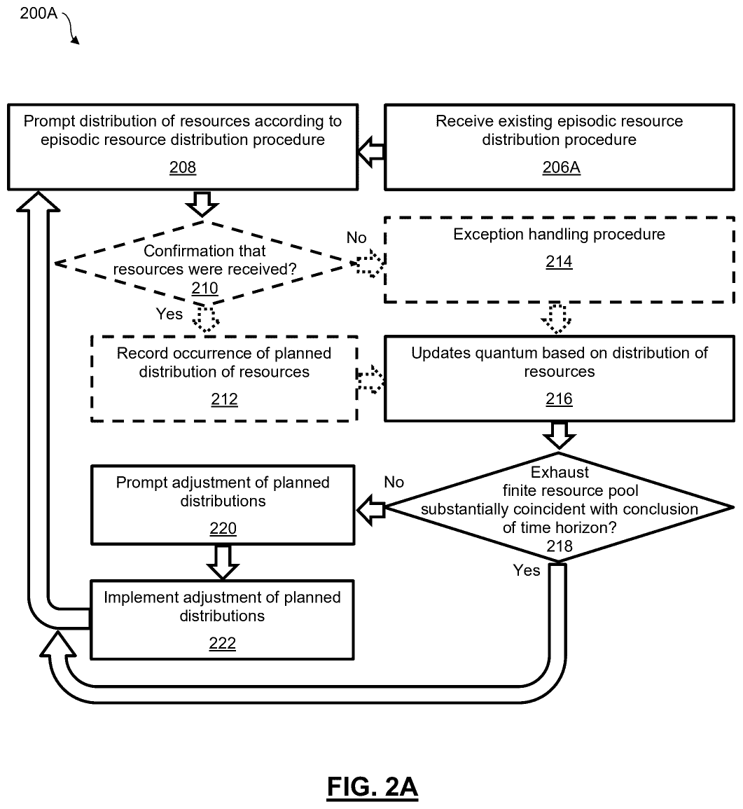

Reference is now made to FIG. 2, which is a flow chart showing an illustrative computer-implemented method for supply distribution, indicated generally at reference 200.

At step 202, the method 200 receives an indication of a time horizon, which may be a fixed time horizon, for example one day, one week, one month, one year, ten years, etc., or may be an infinite time horizon. At step 204, the method 200 receives an indication of a quantum of a finite resource pool. The quantum received at step 204 may be for any type of resource pool as discussed above in the context of FIG. 1, and as such the quantum may be renewable by a replenishment rate, which may be a fixed replenishment rate or a variable replenishment rate. Steps 202 and 204 may be performed in reverse order, or substantially simultaneously.

At step 206, the method 200 determines, from the time horizon received at step 202 and the quantum received at step 204, an episodic resource distribution procedure. The episodic resource distribution procedure comprises planned distributions of the resources, where the planned distributions are adapted to exhaust the finite resource pool substantially coincident with conclusion of the time horizon. The episodic resource distribution procedure may be any type of episodic resource distribution procedure as discussed above in the context of FIG. 1, and as such the episodic resource distribution procedure may be a periodic resource distribution procedure or a sporadic resource distribution procedure, and may be fixed or may be adjustable.

At step 208, the method 200 prompts distribution of the resources according to the episodic resource distribution procedure. In an automated manufacturing or assembly facility, where components may be moved from storage to an assembly line, or an automated distribution facility may dispatch physical resources via autonomous drones to designated locations; these may be airborne drones or land-based drones, which may be wheeled, tracked, or legged, for example. Another automated implementation of step 208 may be applied in a charitable or philanthropic context where an automated transfer of funds from a foundation to a grant recipient may be performed. Alternatively, one or more communications may be sent to human personnel directing those personnel to effect distribution of the resources according to the episodic resource distribution procedure. For example, a plant manager may be directed to cause components to be moved from storage to an assembly line, or a manager of a distribution facility may dispatch physical resources via human-driven vehicles, or a financial manager may transmit funds electronically or by check.

At optional step 210, the method 200 monitors for confirmation from a target of the resources that the resources have been received. For example, a recipient of the resources may send an electronic acknowledgement that the resources have been received. This may be done automatically, or manually. For example, a recipient of a delivery of physical supplies may manually transmit a confirmation, or where physical supplies are transferred from an autonomous drone to a receiving unit at an automated or semi-automated receiving facility, the receiving facility may automatically initiate transmission of a signal confirming receipt. Where an automated transfer of funds from a foundation to a grant recipient is performed, the recipient's financial institution may acknowledge receipt of the transfer in the grantee's account, in either an automated or a manual manner, or the grantee may do so. Responsive to receiving the confirmation within an expected period of time (“yes” at step 210), the method 200 proceeds to optional step 212 and records the occurrence of the planned distribution of the resources. For example, in some charitable contexts, there may be legal requirements for confirming the transfer of funds. If a confirmation is not received within an expected period of time (“no” at step 210), the method proceeds to optional step 214 for exception handling. The nature of the exception handling will depend on the nature of the resources, and the context, and will be within the capability of one of ordinary skill in the art, now informed by the present disclosure.

After step 208 (or after step 212 or step 214 if step 210 is present), the method 200 proceeds to step 216, where the method 200 updates the quantum based on the distribution of the resources that was prompted at step 208, and optionally based on replenishment (which may be positive or negative). For example, a number of doses of vaccine may have been distributed and an additional number may have expired, or a number of goats may have been provided to families but additional goats may have been born. Or, funds may have been disbursed and interest may have accrued.

At step 218, responsive to updating the quantum at step 216, the method 200 evaluates the episodic resource distribution procedure to determine whether it is still adapted to exhaust the finite resource pool substantially coincident with conclusion of the time horizon. While the planned distributions may be known in advance, there may be unexpected replenishment (positive or negative) such that the quantum differs from what would be expected based solely on depletion according to the planned distributions. For example, in the case of animals, a disease may have caused greater than expected attrition among those animals, or the animals may have been fruitful and multiplied at a rate greater than expected. Or, in the case of funds held at a foundation, a portfolio may have performed better or worse than projected.

Responsive to determining that the planned distributions of the resources fail to exhaust the finite resource pool substantially coincident with the conclusion of the time horizon (“no” at step 218), the method proceeds to step 220. At step 220, the method prompts adjustment of the planned distributions of the resources to substantially coincide with the conclusion of the time horizon. The prompt at step 220 may result in automated adjustment based on the updated quantum from step 216, or may solicit an adjustment from a human individual. The method then proceeds to step 222 to implement the adjustment. The planned distributions can be increased or decreased, as appropriate. After step 222, or after step 218 if it is therein determined that the planned distributions of the resources will exhaust the finite resource pool substantially coincident with the conclusion of the time horizon (“yes” at step 218), the method 200 returns to step 208 to prompt the next distribution of the resources according to the episodic resource distribution procedure (which may be adjusted pursuant to step 220).

In an alternate embodiment, the method 200 may be performed using an episodic resource distribution procedure that has already been determined, with steps 202 and 204 omitted. Such a procedure is shown in FIG. 2A, with like reference numerals denoting like features but with the suffix “A”. Thus, at step 206A, the method 200A receives an existing episodic resource distribution procedure comprising planned distributions of resources adapted to exhaust a finite resource pool substantially coincident with conclusion of a time horizon. The remaining steps of the method 200A are similar to those of the method 200, with like reference numerals denoting like features.

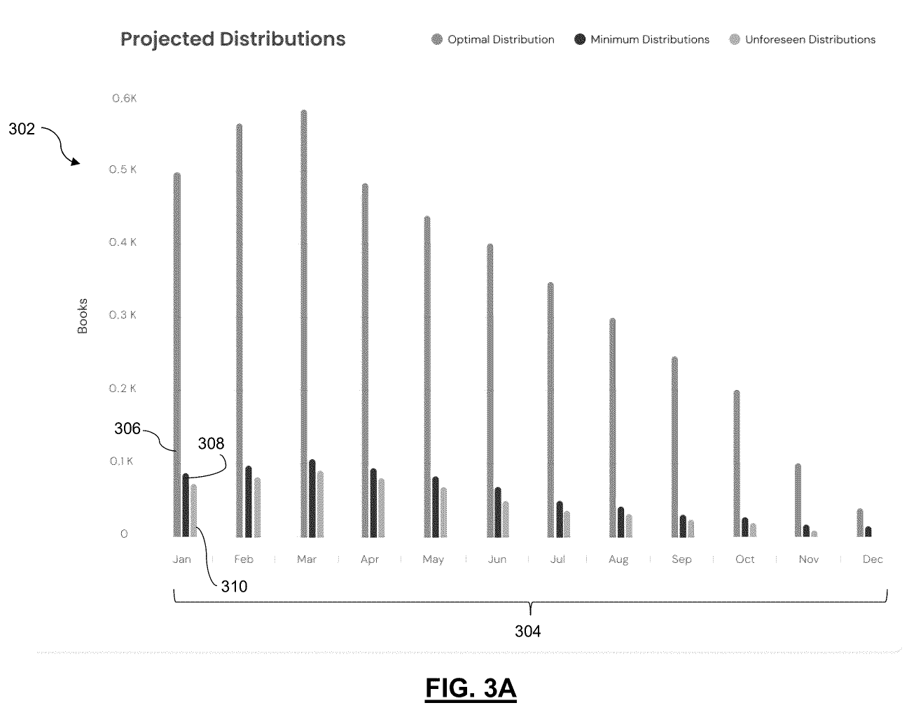

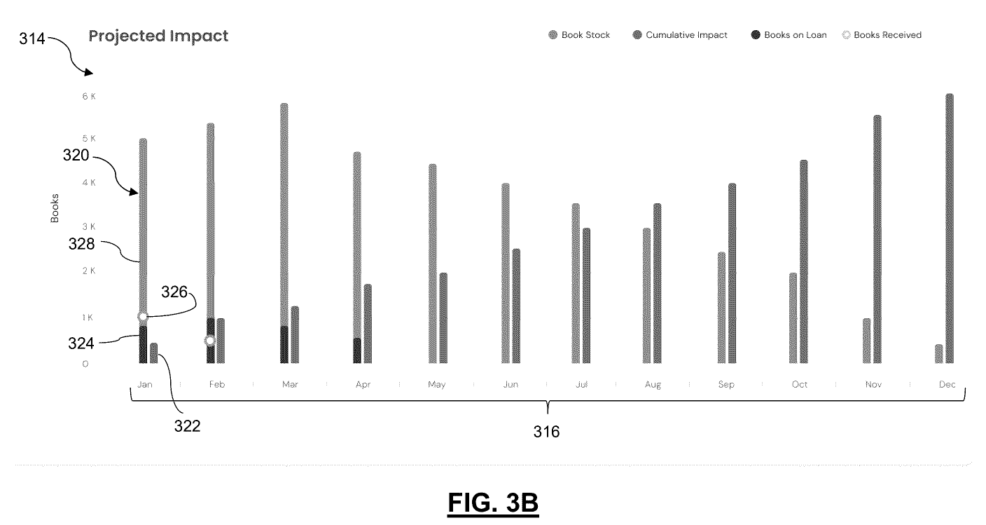

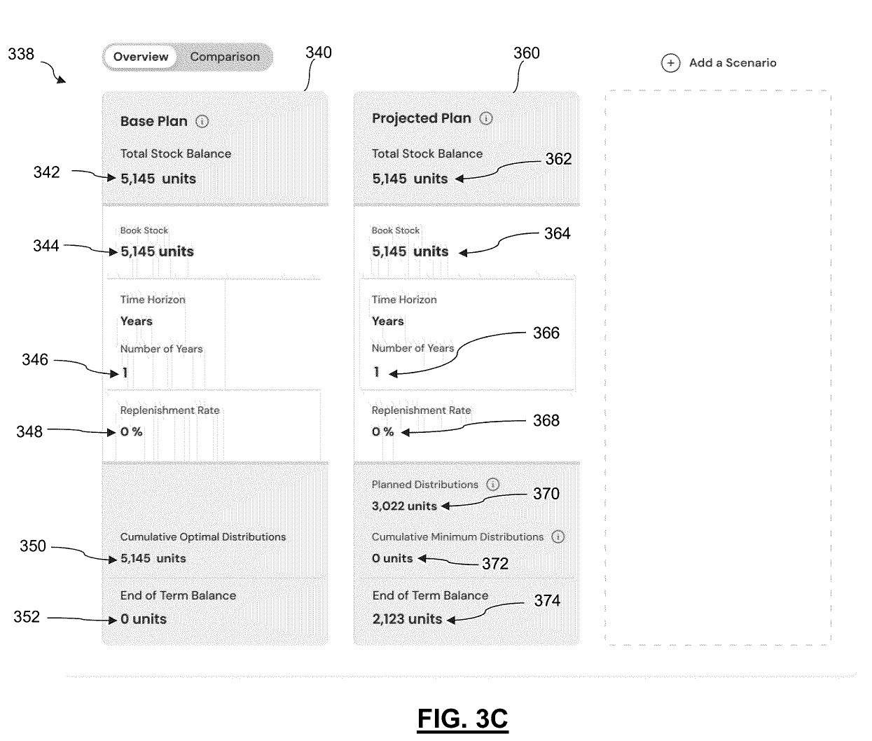

Reference is now made to FIGS. 3A through 3C, which show certain illustrative aspects of non-limiting implementations of the methods 100, 100A, 200, 200A described above.

As noted above, in the case of a philanthropic target mission to improve literacy, target-mission-supporting objectives that include distribution of physical supplies may include procurement and delivery of books, and one example of a unit resource requirement may be a specialized “learn to read” book. Here, the correlation between the respective unit resource requirement and the projected impact is that (assuming an available teacher) one book will equip one student to learn to read.

FIG. 3A shows one non-limiting illustration of how an episodic resource distribution procedure comprising planned distributions can be displayed, for example on a display screen of a computing device, in the context of a philanthropic target mission to improve literacy as described above. FIG. 3A shows the episodic resource distribution procedure as a bar graph 302 showing distributions for each month of a one year time horizon 304. The bar graph 302 shows, for each month, an optimal distribution 306, a minimum distribution 308, and an unforeseen distribution 310 (the latter being zero for December). The distribution in each month is one episode of the episodic resource distribution procedure.

The optimal distribution 306 represents the optimal distribution each month, based on the desired impact and the time horizon 304, taking into account relevant constraints and rules. For example, the number of available teachers, in conjunction with a specified student-to-teacher ratio, may impose a constraint whereby additional distribution of books beyond a certain number would not produce any additional impact. The constraints and rules may also be legal constraints and rules and/or organizational constraints and rules. Preferably, the optimal distribution will be one that is adapted to exhaust the finite resource pool substantially coincident with conclusion of the time horizon 304.

The minimum distribution 308 may be selected manually by a user, or calculated. For example, in the context of a a philanthropic target mission to improve literacy, if the teacher salaries are funded by a different program (e.g. another charity, or government) based on certain criteria, there may be a requirement that a minimum number of books be provided for a specified period, such as enough to supply one class so as to justify the employment of one teacher. The minimum distribution 308 may also be specified by legal or organizational rules.

The unforeseen distributions account for potential unforeseen circumstances. For example, some books may be rendered unusable by vandalism and require replacement.

FIG. 3B shows a dashboard 314 indicating the projected impact of one of the target-mission-supporting objectives in support of the mission for each month of a one year time horizon 316. As with the episodic resource distribution procedure in FIG. 3A, the dashboard in FIG. 3B can be displayed on a display screen of a computing device. In the illustrative embodiment shown in FIG. 3B, the unit resource requirement is a “learn to read” book, and the distributed resources and the unit resource requirement (i.e. number of books provided) are used to show the projected impact. More particularly, the dashboard shows the number of books remaining in the resource pool (“book stock”) and presents the projected impact as the number of children who will have learned to read; in the illustrated embodiment this will have a one-to-one correspondence with the number of books distributed. As described above, the dashboard shown in FIG. 3B can be updated after executing each episode of the resource distribution procedure to show the updated projected impact.

FIG. 3B shows, for each month of the one year time horizon 316, a current stock 320 of books, a cumulative impact 322 of the books distributed, a number of books on loan 324, and a number of books received 326. The number of books on loan 324 is shown as an internal bar within the current stock 320; thus, both the books available to distribute 328 and the books on loan 324 are represented within the current stock 320 of books. The number of books received 326 is shown as a circle overlaid atop the overall bar for the current stock 320 of books.

Cumulative impact is the cumulative result of the distributions that have been made and their desired impact achieved. In the illustrated embodiment, since the book is a unit resource requirement, there is a 1:1 ratio between the number of books distributed and the number of students who learn to read (assuming an available teacher), so each book distributed results in one student learning to read. Thus, as the current stock 320 of books decreases through distributions, the cumulative impact increases by a corresponding number. The total current stock 320 of books increases from January to February and from February to March despite distributions because of the books received 326 in January and February. For example, additional books may be printed or purchased.

Books on loan 324 are those books that are owned by the organization but that have been loaned out (rather than permanently distributed) and returnable although not yet returned. For example, a book may be reusable.

After executing each episode of the episodic resource distribution procedure shown as a bar graph 302 in FIG. 3A, an updated version of the dashboard 314 shown in FIG. 3B may be generated. The updated version of the dashboard 314 updates the projected impact of the selected target-mission-supporting objective(s) using the distributed resources and the unit resource requirement for the selected target-mission-supporting objective(s).

FIG. 3C shows an overview display 338 comparing a base plan with a current projected plan. As with the episodic resource distribution procedure in FIG. 3A and the dashboard in FIG. 3B, the overview display in FIG. 3C can be displayed on a display screen of a computing device.

The overview display 338 includes a base plan block 340. The base plan block 340 shows details of a base plan, which may comprise a software-generated distribution plan for which the planned distributions of the books will exhaust the finite resource pool substantially coincident with the conclusion of the time horizon 346. The base plan block 340 shows a total stock balance 342 and a book stock 344, representing the current stock. In the illustrated embodiment both show the same value as the only resource is books; other embodiments may have more than one type of resource. The base plan block 340 also shows the time horizon 346, in this case 20 years, and a replenishment rate 348, in this case 0% because the books will neither regenerate, nor are the books expected to deteriorate beyond usability within the time horizon (e.g. they will not deteriorate in storage). The base plan block 340 further shows the cumulative optimal distributions 350 required to achieve a zero end-of-term balance 352 at the conclusion of the time horizon. In this case, since the replenishment rate 348 is zero, the cumulative optimal distributions 350 required to achieve a zero end-of-term balance 352 is the same as the total stock balance 342 and book stock 344. The base plan block may, for example, correspond to the episodic resource distribution procedure for which a portion is shown as a bar graph 302 in FIG. 3A.

The overview display 338 also includes a projected plan block 360, which is similar to the base plan block 340 but showing details of a projected plan based on specifically identified planned distributions. Thus, the projected plan block 360 shows a total stock balance 362 and a book stock 364, the one year time horizon 366, and the 0% replenishment rate 368. The projected plan block 360 differs from the base plan block 340 in that the projected plan block 360 does not show cumulative optional distributions, but instead shows the planned distributions 370 as well as cumulative minimum distributions 372 (in this case zero). The projected plan block 360 shows a projected end-of-term balance 374 based on the planned distributions 370.

In the illustrated embodiment, the projected end-of-term balance 374 is 2,123 books, meaning that the planned distributions of the books would fail to exhaust the finite resource pool (total stock balance 362 and a book stock 364) substantially coincident with the conclusion of the one year time horizon 366. Thus, the overview display 338 may prompt a user for adjustment of the planned distributions of the books to substantially coincide with the conclusion of the time horizon 366. For example, software modules may be provided to generate recommendations to bring the projected plan in line with the base plan.

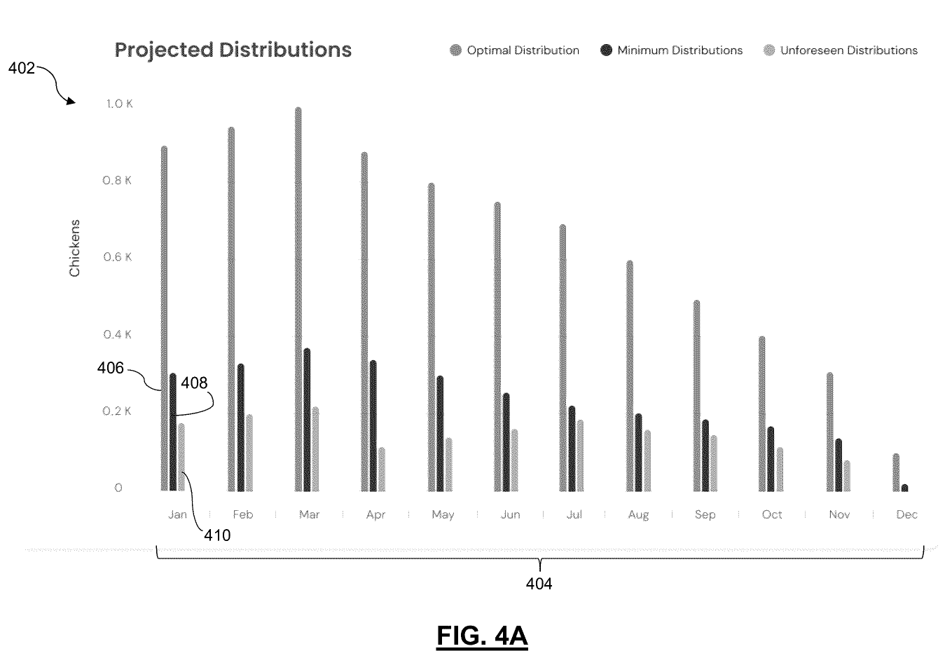

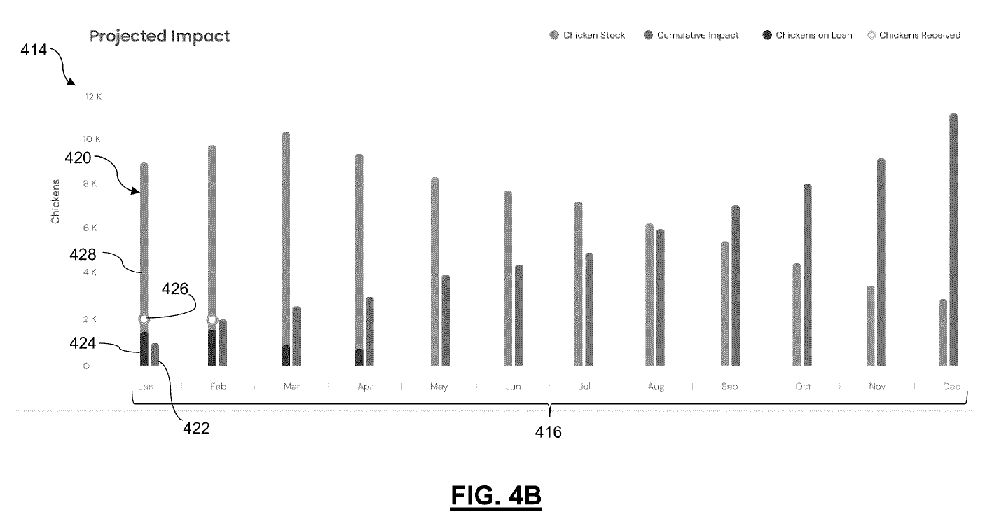

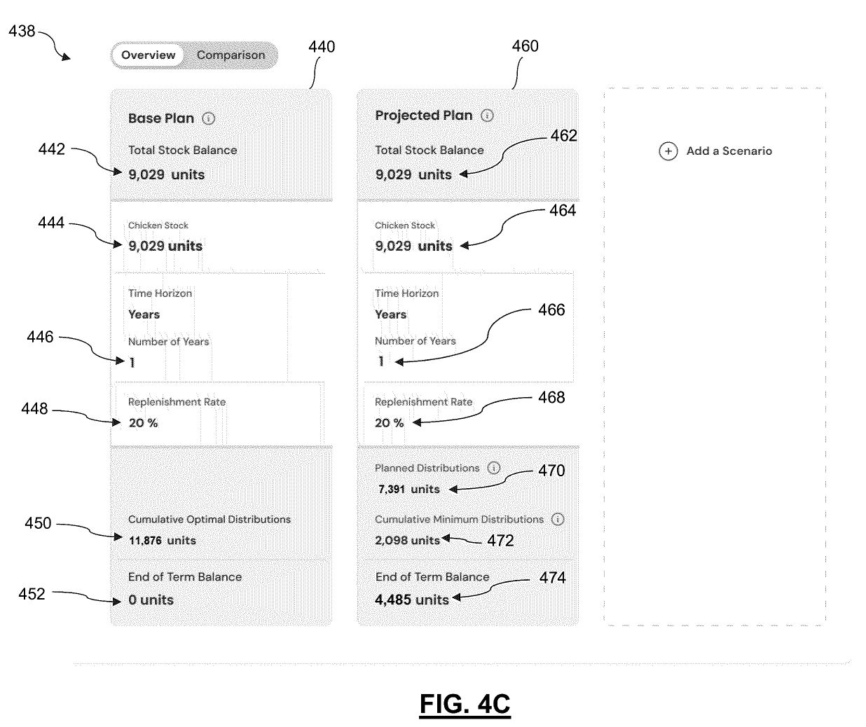

FIG. 4A shows a non-limiting illustration of how an episodic resource distribution procedure comprising planned distributions can be displayed, for example on a display screen of a computing device, in the context of a philanthropic target mission to alleviate persistent hunger in an impoverished geographical region. In this example, one unit resource requirement is a female chicken that can lay eggs (hen) or is expected to lay eggs (pullet), each being referred to hereafter simply as a “chicken”. Similarly to how the literacy example assumes the availability of teachers, for simplicity of illustration the proffered example will assume the availability of male chickens that are capable of reproduction (rooster) or are expected to become so capable (cockerel) but excluding capons.

FIG. 4A shows the episodic resource distribution procedure as a bar graph 402. The bar graph 402 shows distributions for a one year time horizon 404. For each month in the year, the bar graph 402 shows an optimal distribution 406, a minimum distribution 408, and an unforeseen distribution 410 (the latter being zero for December). The distribution in each month is one episode of the episodic resource distribution procedure.

The optimal distribution 406 represents the optimal distribution each month, based on the desired impact and the time horizon 404, with relevant constraints and rules considered. For example, the constraints and rules may relate to egg production and reproduction rate. Preferably, the optimal distribution is adapted to exhaust the finite resource pool substantially coincident with conclusion of the time horizon 404.

The minimum distribution 408 may be a manually selected value or a calculated value. For example, in the context of a philanthropic target mission to alleviate persistent hunger in an impoverished geographical region, the minimum distribution may relate to minimum caloric needs to avoid starvation.

The unforeseen distributions allow for potential unforeseen circumstances, such as the loss of chickens to a disease or other unpredictable cause.

FIG. 4B shows a dashboard 414 indicating the projected impact of one of the target-mission-supporting objective in support of the mission for each month of a one year time horizon 416, and can also be displayed on a display screen of a computing device. As noted above, in the illustrative embodiment shown in FIG. 4B, one of the unit resource requirements is a chicken (laying hen) and the distributed resources and the unit resource requirement (i.e. number of chickens provided) are used to show the projected impact.

FIG. 4B shows, for each month of a single year, a current stock 420 of chickens, a cumulative impact 422 of the chickens distributed, a number of chickens on loan 424, and a number of chickens received 426. The number of chickens on loan 424 is shown as an internal bar within the current stock 420; thus, both the chickens available to distribute 428 and the chickens on loan 424 are represented within the current stock 420 of chickens. The number of chickens received 426 is shown as a circle overlaid atop the overall bar for the current stock 420 of chickens.

Cumulative impact is the cumulative result of the distributions that have been made and their desired impact achieved, and presents the projected impact as the number of families that have a sustainable food supply. Unlike the book example shown in FIG. 3B, here the correspondence between the number of chickens distributed and the number of families having a sustainable food supply is not one-to-one, but is more complex, since a family will need a substantial number of chickens to have a sustainable flock (assuming the availability of roosters). The exact number of chickens will depend on the default size of the family to be fed, the type of chicken(s), the reproduction rate of the chicken(s), and whether the chickens are to be used only for eggs or also for meat, among other factors. Thus, as the current stock 420 of chickens decreases through distributions, the cumulative impact correspondingly increases. The total current stock 420 of chickens increases from January to February and from February to March despite distributions because of the additional chickens received 426 in January and February. For example, additional chickens may be purchased, or may result from reproduction.

Chickens on loan 424 are those chickens that are owned by the organization but that have been loaned out (rather than permanently distributed) and returnable although not yet returned. For example, chickens may be loaned to a breeding program, for example one which teaches people the techniques of chicken farming, and the breeding program may be permitted to keep a portion of the resulting new chickens while returning the loaned chickens and the remaining portion of the new chickens to the organization that lent them.

After executing each episode of the episodic resource distribution procedure shown as a bar graph 402 in FIG. 4A, an updated version of the dashboard 414 shown in FIG. 4B may be generated.

FIG. 4C shows an overview display 438 comparing a base plan with a current projected plan, which can be displayed on a display screen of a computing device.

The overview display 438 shown in FIG. 4C is similar to the overview display 338 shown in FIG. 3C, and includes a base plan block 440 showing details of a base plan for which the planned distributions of the chickens will exhaust the finite resource pool substantially coincident with the conclusion of the time horizon. As such, the base plan block 440 shows a total stock balance 442 and a stock of chickens 444, the time horizon 446, in this case one year, and a replenishment rate 448. Of note, in the base plan block 440 in FIG. 4C, the replenishment rate 448 has a positive, non-zero value, in this case 20% because the chickens are assumed to replenish by reproduction. The indicated reproduction rate is intended to be illustrative, and is not intended to reflect actual biological reproduction rates. The base plan block 440 further shows the cumulative optimal distributions 450 required to achieve a zero end-of-term balance 452 at the conclusion of the time horizon, taking into account the a total stock balance 442 and stock of chickens 444 and the replenishment rate 448. In this case, because the replenishment rate 448 has a positive non-zero value, the cumulative optimal distributions 450 required to achieve a zero end-of-term balance 452 exceeds the initial total stock balance 442 and stock of chickens 444 by an amount corresponding to the replenishment. The base plan block 440 may, for example, correspond to the episodic resource distribution procedure for which a portion is shown as a bar graph 402 in FIG. 4A.

The overview display 438 also includes a projected plan block 460. The projected plan block 460 is similar to the base plan block 340 but shows the details of a projected plan based on specifically identified planned distributions. Thus, the projected plan block 460 shows a total stock balance 462 and a stock of chickens 464, the one year time horizon 466, and the 20% replenishment rate 468 and shows the planned distributions 470 as well as cumulative minimum distributions 472 instead of cumulative optional distributions. The projected plan block 460 shows a projected end-of-term balance 474 based on the planned distributions 470, the total stock balance 462 and the stock of chickens 464, and the 20% replenishment rate 468.

In the illustrated embodiment, the projected end-of-term balance 474 is a positive non-zero number of chickens, meaning that the planned distributions of the chickens would fail to exhaust the finite resource pool (total stock balance 462 and stock of chickens 464) substantially coincident with the conclusion of the one year time horizon 466. Thus, the overview display 438 may prompt a user for adjustment of the planned distributions of the chickens to substantially coincide with the conclusion of the time horizon 466.

While the embodiment described in the context of FIG. 4C shows a positive replenishment rate, it is also possible for the replenishment rate to be negative. For example, a stockpile of vaccines may have a negative replenishment rate because the vaccines may expire, or for livestock in a context where they are not expected to reproduce.

As noted above, in many contexts a unit resource requirement can be usefully expressed as a dollar (or other currency) value, so that it is possible to express the projected impact in a dollar (or other currency) value. For example, X dollars may result in Y books, or Y chickens, with a corresponding projected impact. Bar graphs showing episodic resource distribution procedures, dashboards, and overview displays as shown in FIGS. 3A to 3C and 4A to 4C can be adapted to the financial context, for example in a charitable or philanthropic context where an (optionally automated) transfer of funds from a foundation to a grant recipient may be performed. Thus, the replenishment rate may be an interest rate, which may be a negative interest rate. Similarly, the dashboard may display funds on loan, for example where funds are loaned at a preferential interest rate (as compared to market rates) to another organization pursuing the same mission. For example, a foundation having a mission to alleviate homelessness may provide a preferential loan to a non-profit corporation that constructs affordable housing.

As can be seen from the above description, the supply distribution mechanisms described herein represent significantly more than merely using categories to organize, store and transmit information and organizing information through mathematical correlations. The supply distribution mechanisms are in fact an improvement to the technology of distribution logistics, as they provide the benefit of an episodic resource distribution procedure for which planned distributions of resources are adapted to exhaust a finite resource pool substantially coincident with conclusion of a specific time horizon. As such, the supply distribution mechanisms are confined to distribution logistics applications.

The present technology may be embodied within a system, a method, a computer program product or any combination thereof. The computer program product may include a computer readable storage medium or media having computer readable program instructions thereon for causing a processor to carry out aspects of the present technology. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present technology may be assembler instructions, instruction-set-architecture (ISA) instructions, machine instructions, machine dependent instructions, microcode, firmware instructions, state-setting data, or either source code or object code written in any combination of one or more programming languages, including an object oriented programming language or a conventional procedural programming language. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to implement aspects of the present technology.

Aspects of the present technology have been described above with reference to flowchart illustrations and/or block diagrams of methods, apparatus (systems) and computer program products according to various embodiments. In this regard, the flowchart and block diagrams in the Figures illustrate the architecture, functionality, and operation of possible implementations of systems, methods and computer program products according to various embodiments of the present technology. For instance, each block in the flowchart or block diagrams may represent a module, segment, or portion of instructions, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Some specific examples of the foregoing may have been noted above but any such noted examples are not necessarily the only such examples. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer readable program instructions may also be stored in a computer readable storage medium that can direct a computer, other programmable data processing apparatus, or other devices to function in a particular manner, such that the instructions stored in the computer readable storage medium produce an article of manufacture including instructions which implement aspects of the functions/acts specified in the flowchart and/or block diagram block or blocks. The computer readable program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

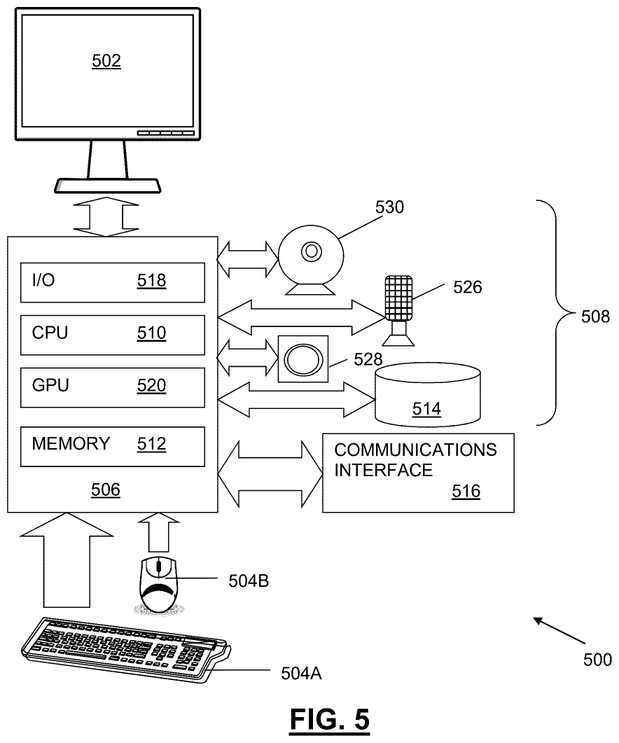

An illustrative computer system in respect of which the technology herein described may be implemented is presented as a block diagram in FIG. 5. The illustrative computer system is denoted generally by reference numeral 500 and includes a display 502, input devices in the form of keyboard 504A and pointing device 504B, computer 506 and external devices 508. While pointing device 504B is depicted as a mouse, it will be appreciated that other types of pointing device, or a touch screen, may also be used.

The computer 506 may contain one or more processors or microprocessors, such as a central processing unit (CPU) 510. The CPU 510 performs arithmetic calculations and control functions to execute software stored in an internal memory 512, preferably random access memory (RAM) and/or read only memory (ROM), and possibly additional memory 514. The additional memory 514 may include, for example, mass memory storage, hard disk drives, optical disk drives (including CD and DVD drives), magnetic disk drives, magnetic tape drives (including LTO, DLT, DAT and DCC), flash drives, program cartridges and cartridge interfaces such as those found in video game devices, removable memory chips such as EPROM or PROM, emerging storage media, such as holographic storage, or similar storage media as known in the art. This additional memory 514 may be physically internal to the computer 506, or external as shown in FIG. 5, or both.

The computer system 500 may also include other similar means for allowing computer programs or other instructions to be loaded. Such means can include, for example, a communications interface 516 which allows software and data to be transferred between the computer system 500 and external systems and networks. Examples of communications interface 516 can include a modem, a network interface such as an Ethernet card, a wireless communication interface, or a serial or parallel communications port. Software and data transferred via communications interface 516 are in the form of signals which can be electronic, acoustic, electromagnetic, optical or other signals capable of being received by communications interface 516. Multiple interfaces, of course, can be provided on a single computer system 500.

Input and output to and from the computer 506 is administered by the input/output (I/O) interface 518. This I/O interface 518 administers control of the display 502, keyboard 504A, external devices 508 and other such components of the computer system 500. The computer 506 also includes a graphical processing unit (GPU) 520. The latter may also be used for computational purposes as an adjunct to, or instead of, the CPU 510, for mathematical calculations.

The external devices 508 include a microphone 526, a speaker 528 and a camera 530. Although shown as external devices, they may alternatively be built in as part of the hardware of the computer system 500.

The various components of the computer system 500 are coupled to one another either directly or by coupling to suitable buses.

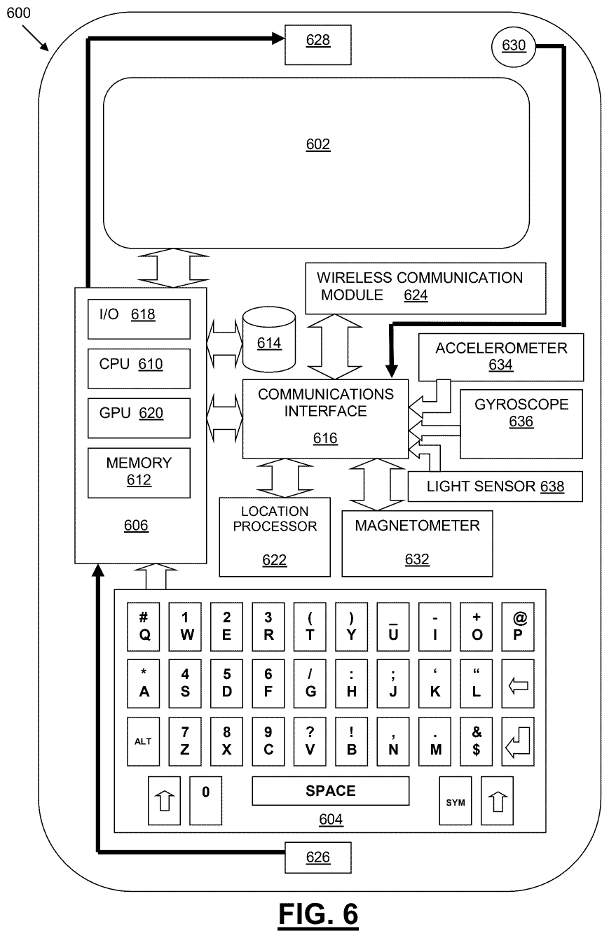

FIG. 6 shows an illustrative networked mobile wireless telecommunication computing device in the form of a smartphone 600. The smartphone 600 includes a display 602, an input device in the form of keyboard 604 and an onboard computer system 606. The display 602 may be a touchscreen display and thereby serve as an additional input device, or as an alternative to the keyboard 604. The onboard computer system 606 comprises a central processing unit (CPU) 610 having one or more processors or microprocessors for performing arithmetic calculations and control functions to execute software stored in an internal memory 612, preferably random access memory (RAM) and/or read only memory (ROM) is coupled to additional memory 614 which will typically comprise flash memory, which may be integrated into the smartphone 600 or may comprise a removable flash card, or both. The smartphone 600 also includes a communications interface 616 which allows software and data to be transferred between the smartphone 600 and external systems and networks. The communications interface 616 is coupled to one or more wireless communication modules 624, which will typically comprise a wireless radio for connecting to one or more of a cellular network, a wireless digital network or a Wi-Fi network. The communications interface 616 will also typically enable a wired connection of the smartphone 600 to an external computer system. A microphone 626 and speaker 628 are coupled to the onboard computer system 606 to support the telephone functions managed by the onboard computer system 606, and a location processor 622 (e.g. including GPS receiver hardware) may also be coupled to the communications interface 616 to support navigation operations by the onboard computer system 606. One or more cameras 630 (e.g. front-facing and/or rear facing cameras) may also be coupled to the onboard computer system 606, as may be one or more of a magnetometer 632, accelerometer 634, gyroscope 636 and light sensor 638. Input and output to and from the onboard computer system 606 is administered by the input/output (I/O) interface 618, which administers control of the display 602, keyboard 604, microphone 626, speaker 628, camera 630, magnetometer 632, accelerometer 634, gyroscope 636 and light sensor 638. The onboard computer system 606 may also include a separate graphical processing unit (GPU) 620. The various components are coupled to one another either directly or by coupling to suitable buses.

The term “computer system”, “data processing system” and related terms, as used herein, is not limited to any particular type of computer system and encompasses servers, desktop computers, laptop computers, networked mobile wireless telecommunication computing devices such as smartphones, tablet computers, as well as other types of computer systems.

Thus, computer readable program code for implementing aspects of the technology described herein may be contained or stored in the memory 612 of the onboard computer system 606 of the smartphone 600 or the memory 512 of the computer 506, or on a computer usable or computer readable medium external to the onboard computer system 606 of the smartphone 600 or the computer 506, or on any combination thereof.

Finally, the terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description has been presented for purposes of illustration and description, but is not intended to be exhaustive or limited to the form disclosed. Many modifications and variations will be apparent to those of ordinary skill in the art without departing from the scope of the claims. The embodiment was chosen and described in order to best explain the principles of the technology and the practical application, and to enable others of ordinary skill in the art to understand the technology for various embodiments with various modifications as are suited to the particular use contemplated.

One or more currently preferred embodiments have been described by way of example. It will be apparent to persons skilled in the art that a number of variations and modifications can be made without departing from the scope of the claims. In construing the claims, it is to be understood that the use of a computer to implement the embodiments described herein is essential.

What is claimed is:

1. A computer-implemented method for supply distribution, the method comprising:
receiving an indication of a target mission;
identifying a plurality of target-mission-supporting objectives associated with the target mission and presenting the target-mission-supporting objectives, wherein:
each target-mission-supporting objective has a unit resource requirement; and
there is a correlation between the respective unit resource requirement and a projected impact of the respective target-mission-supporting objective in support of the target mission;
receiving a selection of at least one of the target-mission-supporting objectives, wherein at least one of the selected at least one of the target-mission-supporting objectives includes distribution of physical supplies;
receiving an indication of a time horizon;
receiving an indication of a quantum of a finite resource pool;
from the time horizon and the quantum, determining an episodic resource distribution procedure comprising planned distributions of resources adapted to exhaust the finite resource pool substantially coincident with conclusion of the time horizon;
generating a dashboard indicating the projected impact of each selected one of the target-mission-supporting objectives in support of the mission;
causing the dashboard to be displayed on a display device;
causing execution of at least a first episode of the resource distribution procedure, whereby the resources are distributed to the selected at least one of the target-mission-supporting objectives to cause the distribution of the physical supplies;
after executing each episode of the resource distribution procedure, generating an updated dashboard updating the projected impact of each selected one of the target-mission-supporting objectives in the dashboard using the distributed resources and the unit resource requirement for the respective selected at least one of the objectives to calculate the updated projected impact; and
causing the updated dashboard to be presented on the display device.

2. The method of claim 1, wherein, for the selected at least one target-mission-supporting objective that includes distribution of physical supplies:
each correlation is between the respective unit resource requirement and a volume of the respective physical supplies;
whereby the projected impact of the respective target-mission-supporting objective in support of the target mission is measured by the volume of the respective physical supplies that is distributed.

3. The method of claim 1, wherein receiving the identification of the target mission comprises:
presenting a plurality of sample mission-supporting objectives, wherein each of the sample mission-supporting objectives represents a sample mission;
receiving a selection of one of the sample objectives; and
identifying the sample mission represented by the selected one of the sample mission-supporting objectives as the target mission.

4. The method of claim 1, wherein receiving the identification of the target mission and identifying a plurality of target-mission-supporting objectives associated with the target mission comprises:
maintaining a database of potential mission-supporting objectives, wherein:
each of the potential mission-supporting objectives supports a particular one of a plurality of potential missions; and
for a subset of the potential missions, each of the potential missions in the subset is supported by a plurality of the potential mission-supporting objectives;
receiving a selection of one of the potential mission-supporting objectives; and
identifying as the plurality of mission-supporting objectives associated with the target mission those ones of the potential mission-supporting objectives supporting an identical one of the plurality of potential missions as the selected one of the potential mission-supporting objectives.

5. The method of claim 1, wherein the target mission is a philanthropic target mission.

6. The method of claim 1, wherein the quantum is renewable by a replenishment rate.

7. The method of claim 1, wherein the episodic resource distribution procedure is adjustable.

8. The method of claim 1, wherein the time horizon is infinite.

9. The method of claim 1, further comprising:
before causing execution of the first episode of the resource distribution procedure, causing an initial version of the dashboard to be presented on the display device.

10. A computer program product comprising at least one tangible, non-transitory computer-readable medium containing instructions which, when executed by a computer, cause the computer to implement the method of claim 1.

11. A data processing system comprising at least one processor and memory containing instructions which, when executed by the data processing system, cause the data processing system to implement the method of claim 1.

12. A computer-implemented method for supply distribution, the method comprising:
receiving an indication of a time horizon;
receiving an indication of a quantum of a finite resource pool;
from the time horizon and the quantum, determining an episodic resource distribution procedure comprising planned distributions of resources adapted to exhaust the finite resource pool substantially coincident with conclusion of the time horizon; and
prompting distribution of the resources according to the episodic resource distribution procedure.

13. The method of claim 12, further comprising:
monitoring for confirmation from a target of the resources that the resources have been received; and
responsive to receiving the confirmation, recording occurrence of the respective planned distribution of the resources.

14. The method of claim 12, further comprising:
updating the quantum;
responsive to updating the quantum, evaluating the episodic resource distribution procedure; and
responsive to determining that the planned distributions of the resources fail to exhaust the finite resource pool substantially coincident with the conclusion of the time horizon, prompting adjustment of the planned distributions of the resources to substantially coincide with the conclusion of the time horizon.

15. The method of claim 12, wherein the quantum is renewable by a replenishment rate.

16. The method of claim 12, wherein the episodic resource distribution procedure is adjustable.

17. The method of claim 12, wherein the time horizon is infinite.

18. A computer program product comprising at least one tangible, non-transitory computer-readable medium containing instructions which, when executed by a computer, cause the computer to implement the method of claim 12.

19. A data processing system comprising at least one processor and memory containing instructions which, when executed by the data processing system, cause the data processing system to implement the method of claim 12.

20. A computer-implemented method for supply distribution, the method comprising:
receiving an episodic resource distribution procedure comprising planned distributions of resources adapted to exhaust a finite resource pool substantially coincident with conclusion of a time horizon;
recording the planned distributions of the resources upon occurrence thereof;
updating the quantum at least according to the occurrence of the planned distributions of the resources;
responsive to updating the quantum, evaluating the episodic resource distribution procedure; and
responsive to determining that the planned distributions of the resources fail to exhaust the finite resource pool substantially coincident with the conclusion of the time horizon, prompting adjustment of the planned distributions of the resources to substantially coincide with the conclusion of the time horizon.

21. The method of claim 20, wherein:
the quantum is renewable by a replenishment rate; and
updating the quantum comprises updating the quantum according to the replenishment rate.

22. The method of claim 20, wherein the time horizon is infinite.

23. A computer program product comprising at least one tangible, non-transitory computer-readable medium containing instructions which, when executed by a computer, cause the computer to implement the method of claim 20.

24. A data processing system comprising at least one processor and memory containing instructions which, when executed by the data processing system, cause the data processing system to implement the method of claim 20.
